(19) United States
(12) Patent Application Publication
(10) Pub. No.: US 2025/0020463 A1
(43) Pub. Date: Jan. 16, 2025

(54) Laser Level System with Automatic Detector Alignment

(71) Applicant: Milwaukee Electric Tool Corporation, Brookfield, WI (US)

(72) Inventor: Julio C. Puentes Flores, Milwaukee, WI (US)

(21) Appl. No.: 18/680,025

(22) Filed: May 31, 2024

Related U.S. Application Data
(60) Provisional application No. 63/513,652, filed on Jul. 14, 2023.

(51) Int. Cl. G01C 15/00

(52) U.S. Cl. CPC G01C 15/006

(57) ABSTRACT

Various laser level systems that provide for automatic alignment between a laser level and a detector are shown. In one example, a laser level system including a laser level and a detector uses more than one pairing frequency for recognition between the laser level and the detector. The laser level and detector will choose one of the pairing frequencies and the detector will then determine whether the laser frequency matches the selected pairing frequency and send a control signal to the laser level in response to the laser beam with the selected pairing frequency. If the detector determines the laser beam frequency does not match the selected pairing frequency, the detector does not send a control signal.

### CROSS-REFERENCE TO RELATED PATENT APPLICATION

The present application claims the benefit of and priority to U.S. Provisional Application No. 63/513,652 filed on Jul. 14, 2023, which is incorporated herein by reference in its entirety.

### BACKGROUND OF THE INVENTION

The present invention relates generally to the field of tools. The present invention relates specifically to a laser projection device, such as a planar laser level that projects one or more lasers onto a work piece or work surface.

### SUMMARY OF THE INVENTION

One embodiment of the invention relates to a laser level system including a laser level and a detector. The detector includes a laser sensor. The laser level is configured to emit a planar laser beam and rotate relative to the detector such that the planar laser beam traverses across the detector. The laser level and the detector are configured to select a first pairing frequency from a group of pairing frequencies. When the planar laser beam is incident on the laser sensor, the detector determines a frequency of the incident planar laser beam and compares the frequency to the first pairing frequency. When the detector determines that the incident planar laser beam is at the same frequency as the pairing frequency, the detector recognizes the laser level and the detector generates a control signal based on the planar laser beam.

Another embodiment of the invention relates to a laser level alignment system including a detector and a laser level. The detector includes a detector panel. The laser level is configured to emit a laser beam and rotate relative to the detector such that the laser beam traverses across the detector. The detector and laser level are configured to select a first pairing frequency. When the laser beam is incident on the detector panel, the detector determines a frequency of the incident laser beam and compares the frequency to the first pairing frequency. When the detector determines that the incident laser beam is at the same frequency as the first pairing frequency, the detector recognizes the laser level, and the detector generates a control signal based on the laser beam. When the detector determines a frequency of the incident laser beam is different than the first pairing frequency, the detector does not recognize the laser level and the detector does not generate the control signal.

Another embodiment of the invention relates to a method of aligning a laser from a laser level with a detector. The method includes positioning a laser level and a detector in a working environment and the laser level and detector choosing a pairing frequency. The method further includes the laser level emitting a laser at the pairing frequency and rotating the emitted laser such that the emitted laser is received at the detector. The method includes determining whether the received laser is at the pairing frequency and generating a control signal from the detector based on the received laser the pairing frequency and communicating the control signal to the laser level.

In specific embodiments, the laser level is configured such that the emitted laser beam is a vertically oriented planar laser beam. In such embodiments, the laser level is configured to rotate (e.g., rotate the laser generating components) such that emitted vertical laser plane sweeps horizontally over the detector such that the vertical laser plane traverses the detector.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a laser level system, according to an exemplary embodiment.

FIG. 2 is a front view of a detector of the laser level system of FIG. 1, according to an exemplary embodiment.

FIG. 3 is a front view of a detector of the laser level system of FIG. 1, according to another exemplary embodiment.

FIG. 4 is a schematic top view of the laser level system of FIG. 1, according to an exemplary embodiment.

FIG. 5 is a schematic view of the detector of FIG. 2 in an environment with more than one laser level, according to an exemplary embodiment.

FIG. 6 is a graphical illustration of multiple pairing frequencies of the detector and a laser level, according to an exemplary embodiment.

FIG. 7 is a flow chart illustrating a selection process of the detector during alignment, according to an exemplary embodiment.

FIG. 8 is a diagram of method of using the laser level system of FIG. 1, according to an exemplary embodiment

### DETAILED DESCRIPTION

Referring generally to the figures, various embodiments of a laser level system, including a laser level and a laser level detector, are shown. As will be generally understood, a laser level system that includes a laser level and detector with the ability for the laser level to automatically control the projected position of the laser such that it is moved to align with the detector is desirable. Providing a laser level with this functionality reduces setup time by removing the need for a second person to help during setup and/or for a single user to repeatedly walk between points to make adjustments. In a specific embodiment, the laser level automatically aligns vertical planar beam to the detector to reduce setup time.

Applicant has developed improvements to the functionality and/or control of a laser level system. In particular, Applicant has developed a laser lever system that includes a laser level and detector that includes the ability for the laser level to automatically control the projected position of the laser such that it is moved to align with the detector even in busy working environments, in which multiple laser levels are in use, through laser level—detector pairing. In contrast to conventional laser level systems with automatic alignment that may detect a laser point and/or beam from a non-target laser level (i.e., not desired and/or paired laser level), Applicant has developed a system to avoid accidental detection of non-target laser levels. In various specific embodiments, the laser level system discussed herein uses more than one pairing or communication frequency for recognition between the laser level and the detector. In such embodiments, the laser level and detector will randomly choose one of the pairing or communication frequencies and the detector will then only respond to the laser point and/or beam from the chosen communication frequency. In various specific embodiments, each of the more than one pairing or communication frequencies corresponds to a specific laser frequency. Once the detector recognizes the selected pairing frequency, the detector will communicate and/or send a control signal to the laser level. This system allows for improved automatic alignment of the laser level by preventing the detector from responding or sending a control signal to another laser level that has a laser with a different frequency than the selected pairing frequency.

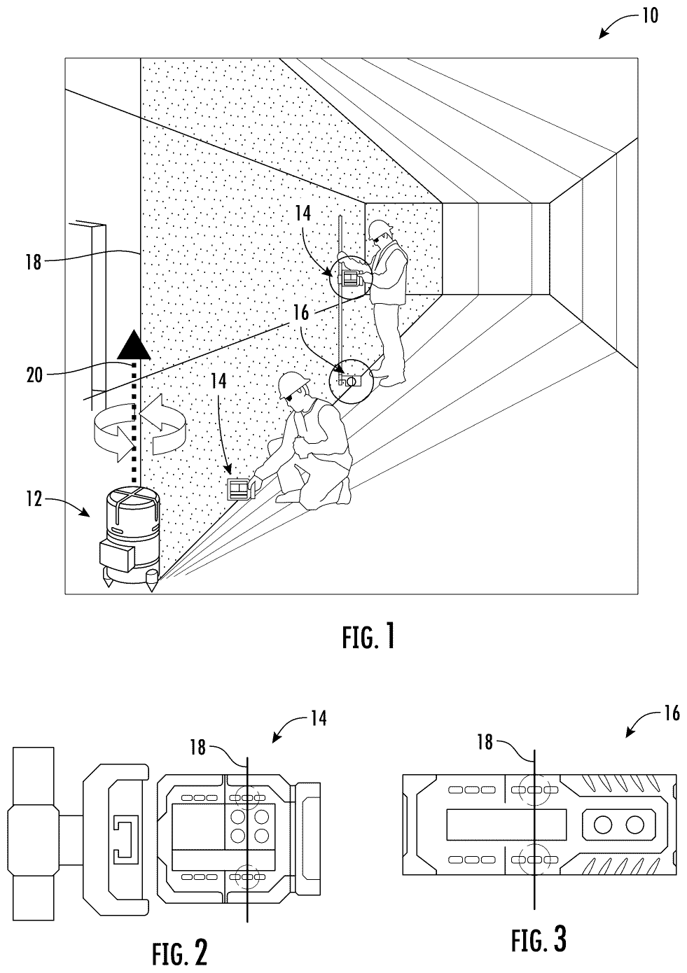

Referring to FIGS. 1-4, a system, shown as laser level system 10, is shown according to an exemplary embodiment. Laser level system 10 includes laser level 12 and detector 14. Laser level 12 emits a laser reference beam, shown as vertical planar laser beam 18. In the embodiment shown, laser level 12 is a rotary laser level configured to rotate about a vertical axis 20 such that laser beam 18 is moved in the generally horizontal direction. In various specific embodiments, the planar laser beam 18 is a vertically oriented planar laser beam. In such embodiments, the laser level 12 is configured to rotate such that the emitted vertically oriented planar laser beam sweeps horizontally over the detector 14 such that the vertically orientated planar lase beam traverses the laser sensor detector 14.

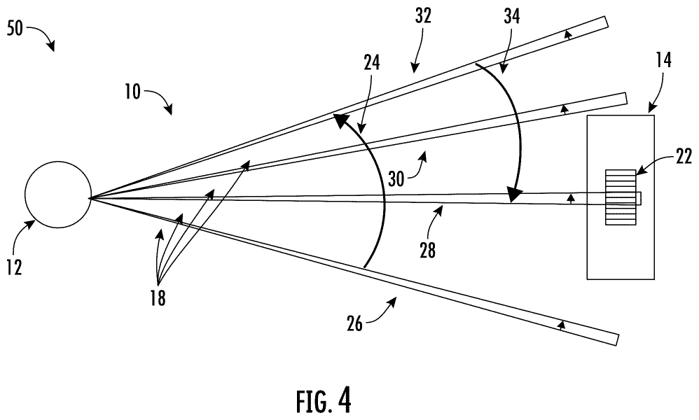

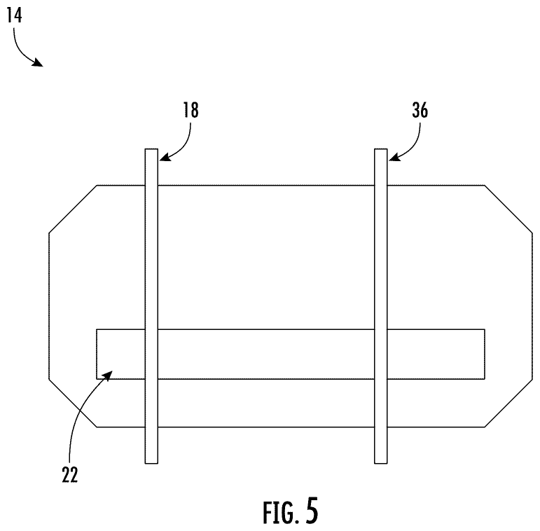

FIG. 2, shows a detailed view of detector 14 according to an exemplary embodiment. Laser beam 18 is shown aligned with a portion of detector 14. FIG. 3 shows a detailed view of a detector 16, shown according to another exemplary embodiment. Laser beam 18 is shown aligned with a portion of detector 16.

Laser level system 10 is configured such that laser level 12 is automatically controlled to rotate laser beam 18 to align with a portion of detector 14 (e.g., such as the center of a detector photodiode array of detector 14). In general, laser level system 10 is configured to determine the position of laser beam 18 relative to detector 14 to control rotation of laser level 12 such that laser beam 18 is projected in the desired position relative to detector 14.

Referring to FIG. 4, details of an automatic alignment process 50 are shown according to an exemplary embodiment. While laser level 12 and detector 14 are being aligned, laser beam 18 from laser level 12 is rotated relatively slowly (e.g., at 10 RPM) such that laser beam 18 traverses across a detector panel 22 of detector 14. In a specific embodiment, laser 18 is rotated in direction 24 with respect to laser level 12 between 5 RPM and 30 RPM, and more specifically at 10 RPM. As shown, laser beam 18 is rotating in direction 24 such that at time zero (T₀) laser beam 18 is emitted along path 26, at time one (T₁) laser 18 is emitted along path 28, at time two (T₂) laser beam 18 is emitted along path 30, at time three (T₃), laser beam 18 is emitted along path 32. In various embodiments, laser level system 10 allows for communication of positional information related to the emitted laser point, line, plane etc., and the detector panel 22. In various specific embodiments, the laser level system 10 calculates a distance between laser level 12 and detector 14 using a speed the laser level 12 is moving and a time for laser beam 18 to pass over detector 14. In other embodiments, laser level system 10 calculates the distance between laser level 12 and detector 14 using a speed the laser level 12 is moving and a number of laser beam 18 pulses that pass over detector 14. These determinations can be used for various purposes such as controlling the automatic alignment of the laser level with the detector

When detector 14 detects laser beam 18, detector 14 communicates to laser level 12 that laser beam 18 has been detected by generating a control signal, such as an electronic signal. As will be discussed in greater detail below, laser level system 10 includes one pairing or communication frequencies (see e.g., 40, 42, 44) to have targeted communication specifically with a paired laser level 12 and not another laser level that is also present and/or being used in the working environment.

Because of the time for detector 14 to determine that laser beam 18 was received, and because of the time to communicate from detector 14 to laser level 12 that laser beam 18 was received, laser level 12 may have continued rotating laser beam 18 past detector panel 22. In the example shown, laser beam 18 has been rotated to path 32. When laser level 12 receives an indication (e.g., a signal) that laser beam 18 was detected by detector 14, laser level 12 rotates laser beam 18 in direction 34 that is opposite of direction 24 until laser beam 18 is aligned detector panel 22, at which point detector 14 signals laser level 12 to stop rotating laser beam 18.

During the alignment process, laser beam 18 is received at detector 14 and/or at detector 16. In various specific embodiments, detector 14 and/or detector 16 are remote controls of laser level 12. Detector panel 22 (e.g., a photodiode array) of detector 14 detects laser beam 18 as laser beam 18 traverses the detector panel 22. In various embodiments, detector 14 generates a signal, such as an electronic signal, based on the detected laser beam 18. The detector 14 analyzes the signal to improve the communication between the detector 14 and laser level 12. For example, a distance between laser level 12 and detector 14 could be calculated allowing a microcontroller unit (MCU), to determine whether gain or amplification is needed (e.g., higher gain at longer distances) for the signal from the detector 14 to obtain the most accurate reading for that signal.

Referring to FIG. 5, a schematic view of detector 14 is shown according to an exemplary embodiment. As will be generally understood, on work sites and/or in working environments there can be more than one laser level and/or laser level system operating simultaneously. In working environments with more than one laser level in use, the detector 14 may detect a laser beam 36 from an unpaired laser level during the automatic alignment process instead of the target laser level 12. Laser level system 10 pairs and/or allows for targeted communication between detector 14 and laser level 12 such that detector 14 will ignore and/or not recognize an unpaired laser level that is also operating in the environment.

When laser level 12 and detector 14 are powered on, a pairing or communication frequency is selected. In a specific embodiment, laser level 12 receives a signal from detector 14 and instructs and/or codes a diode to emit a selected laser beam frequency. Detector 14 includes a processor configured to compare the frequency of an incident planar beam and to the selected pairing frequency. Detector 14 and specifically the processor determines whether the incident laser beam matches the selected pairing frequency and if the incident laser beam matches the selected pairing frequency, the detector 14 communicates to the laser level 12 by sending a control signal. If the processor of detector 14 determines the frequency of the incident laser beam is different than the pairing frequency (i.e. does not match), then the detector does not generate a control signal or send a control signal to the laser level that emitted the laser beam.

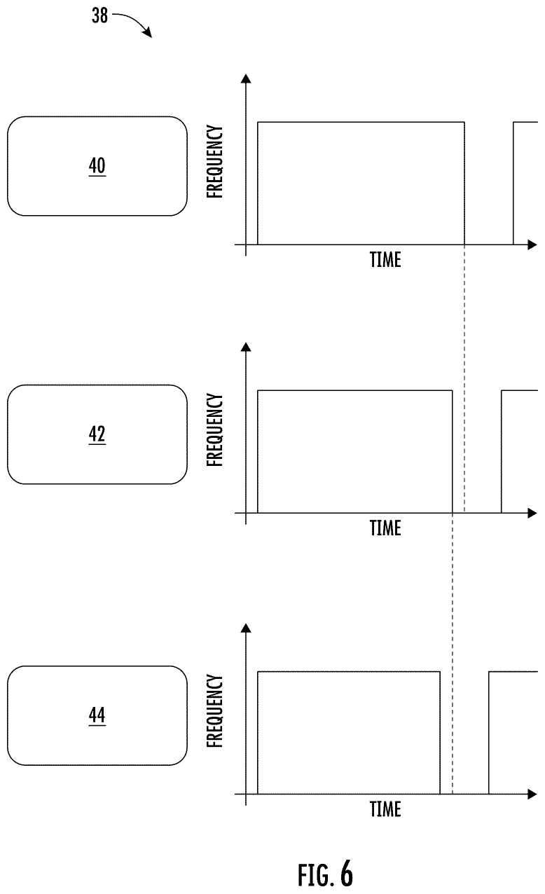

Referring to FIG. 6, a graphical illustration of multiple pairing frequencies used by detector 14 and laser level 12 shown according to exemplary embodiments. Laser level system 10 includes a communication system 38 that includes one or more pairing frequencies 40, 42, 44 to allow for targeted communication specifically with laser level 12 (i.c., paired laser level) and not another laser level that is emitting laser beam 36. In a specific embodiment, laser level system 10 has three pairing frequencies including a first pairing frequency 40, a second pairing frequency 42, and a third pairing frequency 44. In other words, in various specific embodiments, the communication system 38 includes a group of pairing frequencies that includes three pairing frequencies. In various specific embodiments, laser level system 10 includes a different number of pairing frequencies (2, 4, 5, 6, etc.).

Each of the one or more pairing frequencies 40, 42, 44 corresponds to a specific laser frequency. As will generally be understood, the laser frequency is how frequently the laser beam 18 signal repeats itself at a given amplitude over a period of time. Laser level 12 emits laser beam 18 at a certain pulse width modulation (PWM) frequency. The PWM frequency can be adjusted by changing various parameters (i.c., pulse repetition rate, duty cycle, etc.).

1. In a specific embodiment, when there are three pairing frequencies, the first pairing frequency 40 is a laser frequency of about 9.5 kHz (i.e., 9.5 kHz±0.25 kHz), second pairing frequency 42 is a laser frequency of about 10 kHz (i.e., 10 kHz±0.25 kHz), third pairing frequency 44 is a laser frequency of about 10.5 kHz (i.e., 10.5 kHz+0.25 kHz). In other words, in embodiments with three pairing frequencies, the three pairing frequencies include a laser frequency of about 9.5 kHz, a laser frequency of about 10 kHz, and a laser frequency of about 10.5 kHz.

In a specific embodiment, the detector 14 and laser level 12 communicate using Bluetooth. In particular, once detector 14 recognizes the selected pairing frequency 40, 42, 44, the detector 14 will send control signals to laser level 12 using Bluetooth. In other embodiments the detector 14 and laser level 12 communicate in a different manner (i.c., WLAN, RF, infrared, etc.).

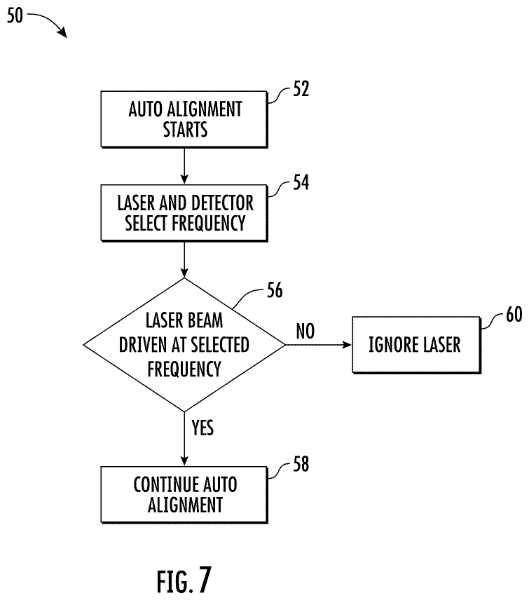

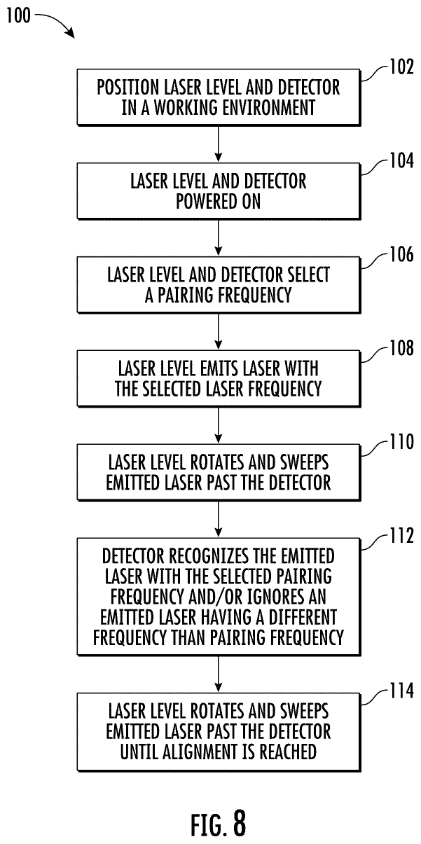

Referring to FIG. 7, a flow chart illustrating an automatic alignment process 50 of laser level system 10 is shown according to an exemplary embodiment. In a first step 52 of the automatic alignment process 50 the laser level 12 and detector 14 are turned on by a user. In a second step 54 of automatic alignment process 50 laser level 12 and detector 14 select one of the pairing frequencies 40, 42, 44 for use during the alignment process 50. In a specific embodiment, a pairing frequency 40, 42, 44 is chosen randomly from the multiple pairing frequencies 40, 42, 44. The selection of the pairing frequency 40, 42, 44 will occur every time a user initiates the automatic alignment process 50. In other words, when a user initiates another alignment process, the detector 14 and laser level 12 are configured to select a pairing frequency. In a specific embodiment, the alignment process 50 is initiated by actuating a button, such as a pairing button.

In a third step 56, laser level 12 will alter a diode based on a received signal from detector 14 and emit laser beam 18 at the frequency of the selected pairing frequency 40, 42, 44. In a fourth step 58 and fifth step 60, detector 14 determines whether a laser beam incident or passing over the detector 14 has a frequency that matches the pairing frequency. As shown in fourth step 58, when laser beam 18 passes over detector 14 and/or detector panel 22, the detector 14 recognizes laser beam 18 because it has the frequency matching the selected pairing frequency 40, 42, 44 and therefore continues the automatic alignment process 50. As described above control signals (e.g., information about position, etc.) are communicated between the detector 14 and laser level 12 and the process continues until laser beam 18 has reached the desired alignment position. Once the target alignment is reached, detector 14 signals laser level 12 to stop rotating laser beam 18.

As shown in fifth step 60, in the event a non-paired laser level emits a laser beam at another frequency (i.e., frequency different from selected pairing frequency), such as laser beam 36, detector 14 will determine the frequency of laser beam 36 is not at the pairing frequency and then ignore and/or fail to respond to the laser level that emitted the laser beam 36. In other words, once detector 14 determines that a laser beam does not have the pairing frequency, the detector does not send a control signal to the laser level. In such an embodiment, detector 14 continues the automatic alignment process 50 with the paired laser level 12 and sends control signals until laser beam 18 has reached the desired alignment position.

Referring to FIG. 8, a method 100 of operating a laser level system 10 is shown, according to an exemplary embodiment. In a first step 102 of operating laser level system 10 a laser level 12 and detector 14 are provided and positioned by a user in a working environment. At second step 104, laser level 12 and detector 14 are powered on by a user to begin automatic alignment process 50.

In a third step 106, laser level 12 and detector 14 choose a pairing frequency 40, 42, 44 for the laser level 12. In fourth step 108, laser level 12 will emit a laser beam 18 at a selected laser frequency that matches the selected pairing frequency 40, 42, 44.

In a fifth step 110, laser level 12 will rotate at a selected speed and sweep the laser beam 18 past or over the detector 14. In a sixth step 112, detector 14 and specifically a processor will determine the laser beam 18 that has a laser frequency that matches the selected pairing frequency 40, 42, 44, then send a control signal in response and/or determine the laser frequency does not match the selected pairing frequency and not send a control signal to the laser level (i.c., ignore the laser beam 36 that has a frequency that does not match the selected pairing frequency). In seventh step 114 after detector 14 has determined laser beam 18 matches the selected pairing frequency 40, 42, 44, detector 14 communicates (i.e., sends control signal) to laser level 12 that laser beam 18 was received and the automatic alignment process 50 with the paired laser beam 18 continues until laser beam 18 has reached the desired alignment position.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (c.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

What is claimed is:

1. A laser level system comprising:
a detector comprising a laser sensor;
a laser level configured to emit a planar laser beam and rotate relative to the detector such that the planar laser beam traverses across the detector;
wherein the detector and the laser level are configured to select a first pairing frequency from a group of pairing frequencies;
wherein, when the planar laser beam is incident on the laser sensor, the detector determines a frequency of the incident planar laser beam and compares the frequency to the first pairing frequency; and
wherein, when the detector determines that the incident planar laser beam is at the same frequency as the first pairing frequency, the detector recognizes the laser level, and the detector generates a control signal based on the planar laser beam.

2. The laser level system of claim 1, wherein, when the detector determines a frequency of the incident planar laser beam is different than the first pairing frequency, the detector does not recognize the laser level and the detector does not generate the control signal based on the planar laser beam.

3. The laser level system of claim 1, wherein the planar laser beam is a vertically oriented planar laser beam.

4. The laser level system of claim 3, wherein the laser level is configured to rotate such that emitted vertically oriented planar laser beam sweeps horizontally over the detector such that the vertically oriented planar laser beam traverses the laser sensor detector.

5. The laser level system of claim 1, wherein the group of pairing frequencies includes three pairing frequencies.

6. The laser level system of claim 5, wherein the first pairing frequency is chosen randomly from the three pairing frequencies.

7. The laser level system of claim 5, wherein the three pairing frequencies include a laser frequency of about 9.5 kHz, a laser frequency of about 10 kHz, and a laser frequency of about 10.5 kHz.

8. The laser level system of claim 1, wherein the control signal generated by the detector is an electronic signal.

9. A laser level alignment system comprising:
a detector comprising:
a detector panel;
a laser level configured to emit a laser beam and rotate relative to the detector such that the laser beam traverses across the detector;
wherein the detector and the laser level are configured to select a first pairing frequency;
wherein, when the laser beam is incident on the detector panel, the detector determines a frequency of the incident laser beam and compares the frequency to the first pairing frequency;
wherein, when the detector determines that the incident laser beam is at the same frequency as the first pairing frequency, the detector recognizes the laser level, and the detector generates a control signal based on the laser beam; and
wherein, when the detector determines a frequency of the incident laser beam is different than the first pairing frequency, the detector does not recognize the laser level and the detector does not generate the control signal.

10. The laser level alignment system of claim 9, wherein, when the laser receives a signal the laser beam was detected by the detector, the laser level rotates the laser beam until the laser beam is aligned with the detector.

11. The laser level alignment system of claim 10, wherein, when the laser beam is aligned with the detector, the detector signals the laser level to stop rotating the laser beam.

12. The laser level alignment system of claim 9, wherein the first pairing frequency is a pulse width modulation frequency.

13. The laser level alignment system of claim 9, wherein the detector and the laser level communicate via Bluetooth.

14. The laser level alignment system of claim 9, wherein the laser beam emitted by the laser level is a vertically oriented planar laser beam, and wherein the laser level is configured to rotate such that emitted vertically oriented planar laser beam sweeps horizontally over the detector such that the vertically oriented planar laser beam traverses the detector.

15. The laser level alignment system of claim 9, wherein the detector panel comprises a photodiode array.

16. The laser level alignment system of claim 9, wherein, when a user initiates another alignment process, the detector and the laser level are configured to select a second pairing frequency.

17. A method of aligning a laser from a laser level with a detector comprising:
positioning a laser level and a detector in a working environment;
choosing a pair frequency;
emitting a laser from the laser level at the pairing frequency and rotating the laser level such that the laser is received at the detector;
determining whether the received laser is at the pairing frequency; and
generating a control signal from the detector based on the received laser at the pairing frequency and communicating the control signal to the laser level.

18. The method of claim 17, further comprising rotating the laser level until the emitted laser reaches an alignment position relative to the detector.

19. The method of claim 18, further comprising sending a signal from the detector to the laser level to stop rotating once the alignment position has been reached.

20. The method of claim 17, further comprising the detector failing to generate a control signal based on a laser at a frequency different than the pairing frequency.
